(19) United States
(12) Patent Application Publication
(10) Pub. No.: US 2014/0327828 A1
(43) Pub. Date: Nov. 6, 2014

(54) DETACHABLE TABLET DISPLAY DEVICE

(71) Applicant: HON HAI PRECISION INDUSTRY CO., LTD., New Taipei (TW)

(72) Inventor: MU-CHI HSU, New Taipei (TW)

(73) Assignee: HON HAI PRECISION INDUSTRY CO., LTD., New Taipei (TW)

(21) Appl. No.: 14/162,741

(22) Filed: Jan. 24, 2014

(30) Foreign Application Priority Data
May 6, 2013 (TW) 102116123

(51) Int. Cl. H04N 5/44

(52) U.S. Cl. CPC H04N 5/4403
USPC 348/552

(57) ABSTRACT

A detachable tablet display device includes a display, and an assisting platform detachably connected to the display. The display includes a touch screen, a CPU, a wireless receiving module electrically connected to the CPU, and a television module electrically connected to the CPU. The wireless receiving module is capable of receiving a wireless network signal.

### BACKGROUND

1. Technical Field

The present disclosure relates to display devices, particularly to a detachable table display device and a display thereof.

2. Description of Related Art

Tablet display devices, such as tablet televisions, may have a large sized display for viewers to comfortably watch television programs. However, such tablet televisions have a single function of receiving television programs, and cannot surf the internet or handle office work like a computer. A computer may be used to install television software and to watch online television. However, size of a computer display is usually small, and it is uncomfortable for the viewers to watch television on the computer display.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a detachable tablet display device.

FIG. 2 is a block diagram of the detachable tablet display device shown in FIG. 1.

### DETAILED DESCRIPTION

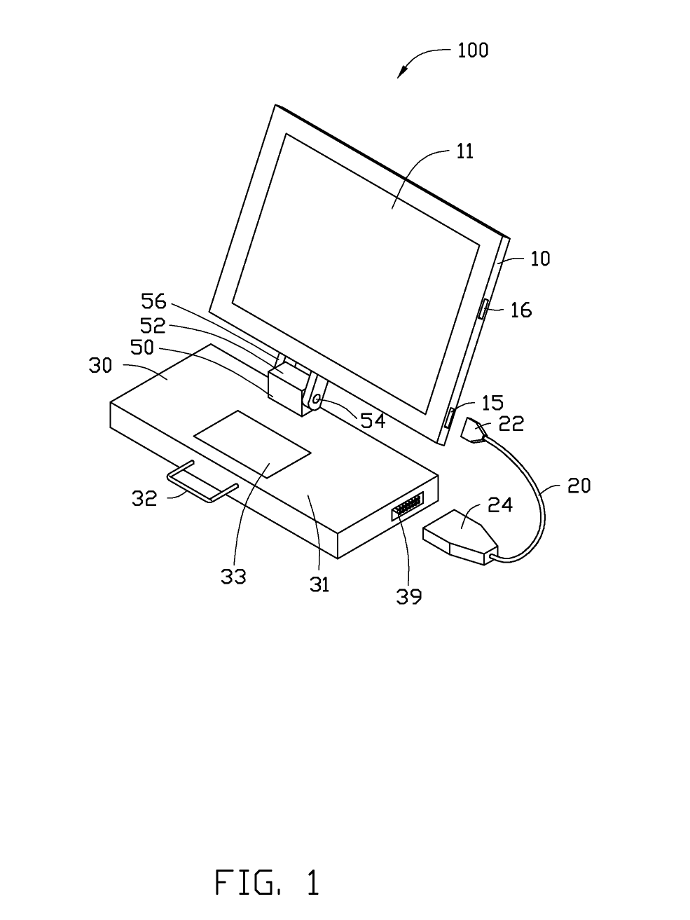

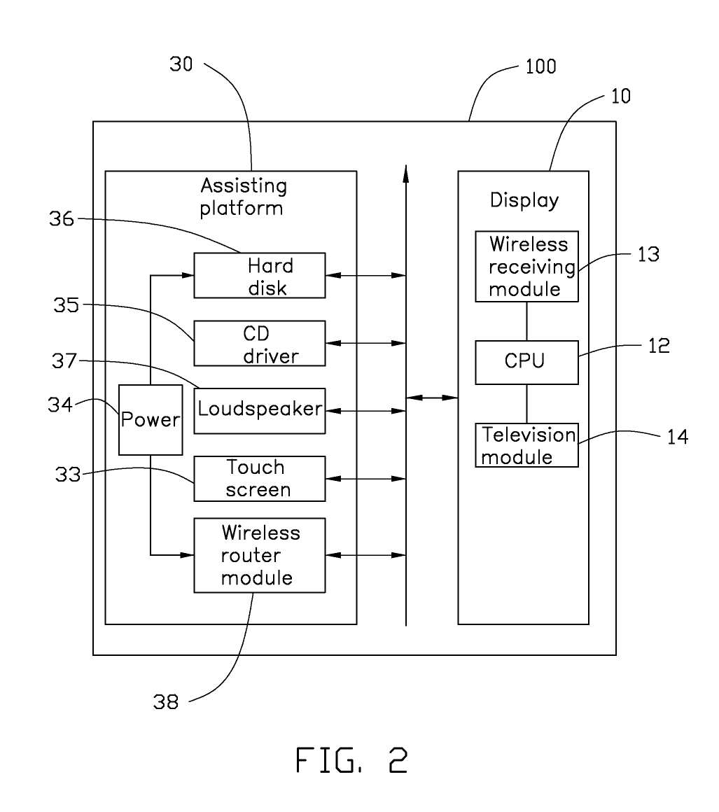

FIGS. 1 and 2 show one embodiment of a detachable tablet display device 100. The detachable tablet display device 100 includes a display 10, a data line 20, an assisting platform 30, and a hinge 50. The display 10 is rotatably connected to the assisting platform 30 via the hinge 50. The data line 20 electrically connects the display 10 and the assisting platform 30.

In the illustrated embodiment, the display 10 has a large size, substantially 20 inches to 40 inches. The display 10 includes a touch screen 11, a central processing unit (CPU) 12, a wireless receiving module 13, and a television module 14. In the illustrated embodiment, the touch screen 11 includes a plurality of thin film transistor (TFT). The touch screen 11 may be a resistive touch screen, a capacitive touch screen, a piezoelectric touch screen, or an infrared touch screen. The wireless receiving module 13 and the television module 14 are respectively electrically connected to the CPU 12. The wireless receiving module 13 is configured to receive a network signal. The television module 14 is configured to receive a television signal.

The display 10 further includes a first transmission port 15 and an electric power port 16. The first transmission port 15 is electrically connected to the CPU 12. The electric power port 16 is configured to connect with an external power (not shown) for continually supplying power to the display 10 when the display 10 is separated from the assisting platform 20 or the display 10 is used singly. The data line 20 includes a first connector 22 and a second connecter 24 respectively positioned at opposite ends. In an alternative embodiment, the display 10 includes other ports, such as an USB port, for inputting or outputting datum.

The assisting platform 30 is substantially rectangular, and includes a housing 31 made of magnesium alloy, a handle 32 positioned at an outer side surface of the housing 31, a touch screen 33 positioned on a top surface of the housing 31, a power 34, a compact disc driver (CD driver) 35, a hard disk 36, a loudspeaker 37, a wireless router module 38, and a second transmission port 39. Both of the power 34, the CD driver 35, the hard disk 36, the loudspeaker 37, and the wireless router module 38 are received in the housing 31. The CD driver 35, the hard disk 36, the loudspeaker 37, and the wireless router module 38 are electrically connected to the power 34. The second transmission port 39 is positioned at a side surface of the housing 31, and is electrically connected to the power 34, the CD driver 35, the hard disk 36, the loudspeaker 37, and the touch screen 33. The first connector 22 of data line 20 is detachably inserted into the first transmission port 15, and the second connector 24 is detachably inserted into the second transmission port 39, thus the CPU 12 of the display 10 is electrically connected to the power 34, the CD driver 35, and the hard disk 36.

The touch screen 33 is electrically connected to the CPU 12 of the display 10. Thus, the touch screen 33 is an input interface, and the display 10 is an output interface. Users can input commands via the touch screen 33 to control the detachable tablet display device 100, thus it is convenient for users to input or output signals, or control a game interface, and it provides a well watching effect and a well experiencing effect. In the illustrated embodiment, the power 34 is a large sized battery having a large volume, to supply electric power to the detachable tablet display device 100 for a long time. Thus, the detachable tablet display device 100 of the illustrated embodiment can be used outdoors or for an exhibition.

The hard disk 36 can enlarge a storing volume of the display 10, and can store large datum, such as a large video, or a large file. The CD driver 35 is used to read a disk, such as a CD. The loudspeaker 37 is better than a sound card of a computer of a television, and has a large adjustable range of volume. The wireless router module 38 is configured to receive or emit a wireless network signal. The wireless receiving module 13 of the display 10 receives the wireless network signal emitted by the wireless router module 38.

The hinge 50 includes a fixing portion 52 mounted on the assisting platform 30, a pivoting shaft 54, and a bracket 56 mounted on the display 10. The fixing portion 52 defines a positioning hole (not shown), and the bracket 56 defines a pair of fixing holes (not shown). The pivoting shaft 54 is inserted into the positioning hole and the fixing holes, to rotatably connected to the display 10 and the assisting platform 30. The hinge 50 is capable of adjusting an included angle of the display 10 relative to the assisting platform 30. In an alternative embodiment, the display 10 can be connected to the assisting platform 30 by other connecting structures, such as a fastening structure, or a pluggable structure. In an alternative embodiment, the hinge 50 may include a friction disk, a washer, and a restricting member.

In an alternative embodiment, the hinge 50 may be omitted, and the display 10 can be only connected to the assisting platform 30 via the data line 20, allowing easy detachment of the display 10 and the assisting platform 30. The display 10 can he hung on a wall, for example.

The display 10 of the detachable tablet display device 100 can be used with the assisting platform 30. The assisting platform 30 includes the power 34, the hard disk 36, the CD driver 35, the wireless router module 38, which enable enlargement of the functions of the display 10, and allows upgrading of the assisting platform 30. The display 10 also can be used singly, and then users can control the display 10 via the touch screen 11 to watch television, or surf the internet, play games, handle office work, for example.

It is believed that the present embodiments and their advantages will be understood from the foregoing description, and it will be apparent that various changes may be made thereto without departing from the spirit and scope of the embodiments or sacrificing all of its material advantages.

1. A detachable tablet display device, comprising:
a display comprising:
a touch screen,
a central processing unit (CPU), and
a television module electrically connected to the CPU; and
an assisting platform detachably connected to the display, the assisting platform comprising:
a housing, and
a touch screen positioned on a top surface of the housing.

2. The detachable tablet display device of claim 1, wherein a size of the touch screen of the display ranges from about 20 inches to about 40 inches.

3. The detachable tablet display device of claim 1, wherein the touch screen of the display comprises a plurality of thin film transistors.

4. The detachable tablet display device of claim 1, wherein the touch screen of the display comprises an electric power port for connecting to an external electrical power source.

5. The detachable tablet display device of claim 1 further comprising a hinge, the display rotatably connected to the assisting platform by the hinge, the touch screen of the assisting platform is in front of the display and lower than the display.

6. The detachable tablet display device of claim 1 further comprising a data line, wherein the display further comprises a first transmission port electrically connected to the CPU, the assisting platform comprises a second transmission port, the data line electrically connects the display and the assisting platform by connecting between the first transmission port and the second transmission port, the second transmission port is electrically connected to the touch screen of the assisting platform.

7. The detachable tablet display device of claim 6, wherein the assisting platform further comprises a power source electrically connected to the second transmission port, the power source is electrically connected to the CPU via the data line.

8. The detachable tablet display device of claim 6, wherein the assisting platform further comprises a CD driver and a hard disk, each of the CD driver and the hard disk is electrically connected to the CPU via the data line.

9. The detachable tablet display device of claim 1, wherein the assisting platform further comprises a wireless router module, the display further comprises a wireless receiving module, the wireless receiving module receives wireless network signals from the wireless router module.

10. The detachable tablet display device of claim 1, wherein the assisting platform further comprises a handle positioned on the housing.

11. A detachable tablet display device, comprising:
a display comprising:
a touch screen,
a central processing unit (CPU),
a wireless receiving module electrically connected to the CPU, and capable of receiving wireless network signals, and
a television module electrically connected to the CPU; and
an assisting platform detachably connected to the display, the assisting platform comprising:
a housing, and
a touch screen positioned on a top surface of the housing.

12. The detachable tablet display device of claim 11, wherein a size of the touch screen of the display ranges from about 20 inches to about 40 inches.

13. The detachable tablet display device of claim 11, wherein the touch screen of the display comprises an electric power port configured for connecting to an external electrical power source.

14. The detachable tablet display device of claim 11 further comprising a hinge, the display is rotatably connected to the assisting platform by the hinge, the touch screen of the assisting platform is in front of the display and lower than the display.

15. The detachable tablet display device of claim 11 further comprising a data line, wherein the display further comprises a first transmission port electrically connected to the CPU, the assisting platform comprises a second transmission port, the data line electrically connects the display and the assisting platform by connecting between the first transmission port and the second transmission port, the second transmission port is electrically connected to the touch screen of the assisting platform.

16. The detachable tablet display device of claim 15, wherein the assisting platform further comprises a power source electrically connected to the second transmission port, the power source is electrically connected to the CPU via the data line.

17. The detachable tablet display device of claim 15, wherein the assisting platform further comprises a CD driver and a hard disk, each of the CD driver and the hard disk is electrically connected to the CPU via the data line.

18. The detachable tablet display device of claim 11, wherein the assisting platform further comprises a wireless router module emitting the wireless network signals.

19. The detachable tablet display device of claim 11, wherein the assisting platform further comprises a handle positioned on the housing.

20. The detachable tablet display device of claim 11, wherein the touch screen of the display comprises a plurality of thin film transistors.
